(19) United States
(12) Patent Application Publication
(10) Pub. No.: US 2010/0055416 A1
(43) Pub. Date: Mar. 4, 2010

(54) COMPOSITE AND MANUFACTURING METHOD THEREOF

(75) Inventors: Yoo Seong YANG, Daejeon (KR); Eun Sung LEE, Seoul (KR)

Correspondence Address: CANTOR COLBURN, LLP, 20 Church Street, 22nd Floor, Hartford, CT, 06103, US

(73) Assignees: SAMSUNG ELECTRO-MECHANICS CO., LTD., Suwon-si, Gyeonggi-do (KR); SAMSUNG ELECTRONICS CO., LTD., Suwon-si, Gyeonggi-do (KR)

(21) Appl. No.: 12/369,335

(22) Filed: Feb. 11, 2009

(30) Foreign Application Priority Data
Sep. 4, 2008 (KR) 10-2008-0087399

(51) Int. Cl. B32B 7/00; B05D 5/12

(52) U.S. Cl. 428/195.1; 427/123; 427/126.3

(57) ABSTRACT

Disclosed herein is a polymer composite having an electrically conducting material dispersed therein. In the composite, a silane coupling agent may be covalently bonded with a metal oxide impregnated on the surface of the electrically conducting material to surround the electrically conducting material, thereby retaining high dielectric properties and realizing a low dielectric loss.

### CROSS-REFERENCE TO RELATED APPLICATION

This application claims priority to Korean Patent Application No. 2008-87399, filed on Sep. 4, 2008, and all the benefits accruing therefrom under 35 U.S.C. §119, the contents of which in its entirety are herein incorporated by reference.

### BACKGROUND

1. Field

This disclosure is related to a composite and a manufacturing method thereof. More particularly, it is related to a composite in which a conductive material is dispersed in a polymer resin, thus reducing the dielectric loss of the composite.

2. Description of the Related Art

In the electronics industry, mobile products are considered to be highly desirable. Thus, research and development to reduce the size and weight of mobile products while at the same time increasing the performance thereof is being continuously conducted. With the advancement of the miniaturization of passive devices, the manufacture and mounting of these small devices has become more difficult. In order to facilitate miniaturization, components of circuit boards (“PCBs”), such as, for example, passive devices (e.g., resistors, inductors, and/or capacitors) are being housed (embedded) inside the printed circuit board (PCB), instead of mounting them on to the PCB.

In the embedding of passive devices outside or inside the PCB, it may be desirable to use new materials and processes in lieu of conventional materials and processes (e.g., conventional chip resistors and chip capacitors). The embedding of passive devices inside the PCB improves the density of the PCB as well as its reliability. This promotes a decrease in the size and the weight of electronic products. It also promotes a decrease in inductance, which improves electrical performance.

For example, in the case of an embedded capacitor, the surface area of a substrate that contains the capacitor may be reduced, thereby realizing a smaller lightweight product especially when compared with a comparative product that has the capacitor disposed on the surface of the substrate. In addition, the embedding of passive devices facilitates a reduction in the length of electrical wiring, which reduces the inductance and improves electrical performance. In addition, high-frequency noise may be reduced, and the number of solder joints may be decreased, therefore increasing apparatus reliability in addition to reducing manufacturing costs.

Off all of the commercially available passive devices, the resistor and the inductor may be formed through a polymer thick film (PTF) process, which may have some design drawbacks but entails no great difficulty in terms of materials and manufacturing processes. However, it is not as easy to manufacture a capacitor, because of the lack of suitable materials and processes. In general, in order to manufacture an embedded capacitor, it is desirable to have a material that displays a high capacitance and that can be manufactured in a low-temperature process (less than or equal to about 260° C.). Typically, an embedded capacitor needs a capacitance from about 1 picofarad (“pF”) to about 1 microfarad (“μF”) or more depending on the type of material used in the electronic application. When such a capacitor is to be produced in a PTF process, the dielectric loss factor is one of important factors to be considered. Hence, the development of a high dielectric composite having a low dielectric loss factor is desirable.

### SUMMARY

Disclosed herein is a composite having dielectric loss factor of about 10% or less.

Disclosed herein is a method of manufacturing the composite.

Disclosed herein is a capacitor that includes the composite.

Disclosed herein too is a composite wherein a conductive material having a surface impregnated with a metal oxide is dispersed in a polymer resin and a silane coupling agent is covalently bonded with the metal oxide.

Disclosed herein too is a method of manufacturing a composite including preparing a conductive material having a surface impregnated with an oxidizable metal or a metal oxide; mixing the conductive material with a silane coupling agent and then heating the mixture to a temperature of about 100° C. to about 120° C. so that the silane coupling agent is covalently bonded with the oxidizable metal or metal oxide; mixing the conductive material covalently bonded with the silane coupling agent, a polymer resin, and a curing agent, thus forming a composition for forming a composite; and curing the composition for forming a composite.

Disclosed herein too is a capacitor that includes the aforementioned composite.

### BRIEF DESCRIPTION OF THE DRAWINGS

Exemplary embodiments will be more clearly understood from the following detailed description taken in conjunction with the accompanying drawing, in which:

FIG. 1 is a schematic view showing the covalent bonding of a silane coupling agent with the metal oxide on the surface of a conductive material in the process of manufacturing a composite.

### DETAILED DESCRIPTION

Hereinafter, a detailed description will be given of exemplary embodiments with reference to the accompanying drawings.

Aspects, advantages, and features of the present invention and methods of accomplishing the same may be understood more readily by reference to the following detailed description of preferred embodiments and the accompanying drawings. The present invention may, however, may be embodied in many different forms, and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer, or section from another region, layer or section. Thus, a first element, component, region, layer, or section discussed below could be termed a second element, component, region, layer, or section without departing from the teachings of the present invention.

Spatially relative terms, such as “below”, “lower”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “lower” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings. However, the aspects, features, and advantages of the present invention are not restricted to the ones set forth herein. The above and other aspects, features and advantages of the present invention will become more apparent to one of ordinary skill in the art to which the present invention pertains by referencing a detailed description of the present invention given below.

In one embodiment, a composite may be configured such that a conductive material having a surface impregnated with metal oxide is dispersed in a polymer resin. The metal oxide is covalently bonded with a silane coupling agent.

A high dielectric constant (high-k) dielectric may be obtained by increasing the porosity of a given dielectric material. Another method of obtaining a high dielectric constant dielectric is to increase the capacitance (effective dielectric constant) of a given material.

Electrically conducting materials such as carbon black are often dispersed in polymeric resins to form electrodes. The large surface area of the carbon black enables the formation of useful electrodes. However, the interface between the electrically conducting material and the polymer resin plays a role in increasing the dielectric loss (or “tan δ”) of the dielectric.

In order to form a suitable composite that has a high dielectric constant and a low dielectric loss, the electrically conducting material that is dispersed in the polymeric resin may have a metal oxide impregnated on its surface. In other words, the electrically conducting material has disposed upon its surface a metal oxide. A silane coupling agent may be covalently bonded with the metal oxide on the surface of the electrically conducting material. The functional groups of the silane coupling agent may be chemically bonded with the polymer resin, thereby reducing dielectric loss to about 10% or less.

When the silane coupling agent covalently bonds with metal oxide impregnated on the surface of the electrically conducting material, a passivation layer surrounding the electrically conducting material in the polymer resin is formed, thus preventing electrical conductivity between the particles of the electrically conducting material, thereby minimizing the reduction of capacitance of the dielectric. In other words, the formation of a metal oxide layer on the surface of the electrically conducting particles prevents the formation of a percolating network throughout the composite. The presence of the electrically conducting particles with the metal oxide layer disposed thereon increases the dielectric constant of the composite while retaining the insulating properties of the polymer resin.

In the composite, the particles of the electrically conducting material having a surface impregnated with the metal oxide is then dispersed in the polymer resin. The metal oxide may be covalently bonded with the silane coupling agent through heat condensation. In this manner, when a covalent bond is formed between the metal oxide impregnated on the surface of the electrically conducting material and the silane coupling agent, the electrical conduction along the surface of the electrically conducting material due to contact between the particles of the electrically conducting material in the polymer resin is blocked and the interfacial conduction is prevented, thus reducing dielectric loss.

The electrically conducting material may be selected from the group consisting of carbon black, carbon nanotubes, carbon nanowires, carbon fibers, graphite, and a combination thereof.

The metal oxide impregnated on the surface of the electrically conducting material may include an easily oxidizable material such as, for example, a base metal. The metal oxide may be selected from the group consisting of oxides of nickel, zinc, copper, iron, mercury, silver, platinum, gold, tin, lead, and aluminum. The metal oxide may be physically impregnated after being disposed on the surface of the electrically conducting material. It may also be impregnated in a bulk form.

The silane coupling agent covalently bonded with the metal oxide may contain one or more functional groups selected from amongst alkyl groups, vinyl groups, phenyl groups, epoxy groups, carbonyl groups, fluorocarbon groups, ether groups, succinic groups, carboxyl groups, ester groups, mercapto groups, amide groups, amino groups, cyano groups, and nitro groups.

The silane coupling agent may be expressed as shown in the Formula (1):

R—(CH₂)n-Si—(OR′)m (1)

where OR′ is an ethoxy group, a methoxy group, or a methoxyethoxy group, R is one or more functional groups selected from among an alkyl group, a vinyl group, a phenyl group, an epoxy group, a carbonyl group, a fluorocarbon group, an ether group, a succinic group, a carboxyl group, an ester group, a mercapto group, an amide group, an amino group, a cyano group and a nitro group. The functional groups may be chemically bonded with the polymer resin in the composite, thereby minimizing the dangling bonds emanating from the silicon atom, resulting in reduced dielectric loss. The silane coupling agent may function as an adhesion enhancer for enhancing the adhesive bond between the surface of an inorganic material such as the metal oxide and the polymer resin in the composite.

The alkoxysilane (Si—O—R′) group of the silane coupling agent of the Formula (1) may be hydrolyzed by water, thus forming silanol, after which this silanol group may undergo condensation with the surface of metal oxide on the surface of the conductive material, thereby forming a Si—O-M covalent bond. The other functional group R of the silane coupling agent may be bound with an organic material acting as the polymer resin. Consequently, the inorganic material may be chemically bonded with the organic material, thus reducing the dielectric loss.

The silane coupling agent can be selected from the group consisting of an epoxy group-containing silane coupling agent, including 2-(3,4-epoxy cyclohexyl)-ethyltrimethoxysilane, 3-glycidoxytrimethoxysilane, 3-glycidoxypropyltriethoxysilane, and 3-glycidoxypropyltrimethoxysilane of Formula 2 below; an amine group-containing silane coupling agent, including N-(2-aminoethyl)-3-aminopropylmethyldimethoxysilane, N-(2-aminoethyl)-3-aminopropyltrimethoxysilane (H₂N (CH₂)₂NH(CH₂)₃Si(OCH₃)₃), N-(2-aminoethyl)-3-aminopropyl triethoxysilane, 3-aminopropyl trimethoxysilane, 3-aminopropyl triethoxysilane, 3-triethoxysilyl-N-(1,3-dimethylbutylidene) propylamine, and N-phenyl-3-aminopropyltrimethoxysilane; a mercapto group-containing silane coupling agent, including 3-mercaptopropylmethyldimethoxysilane and 3-mercaptopropyltriethoxysilane; an isocyanate group-containing silane coupling agent including 3-isocyanatepropyltriethoxysilane, and compounds represented by Formulas 3 to 8 below. The aforementioned silane coupling agents may have functional groups that can undergo curing, leading to a chemical bond between the electrically conducting material and the polymer resin in the composite.

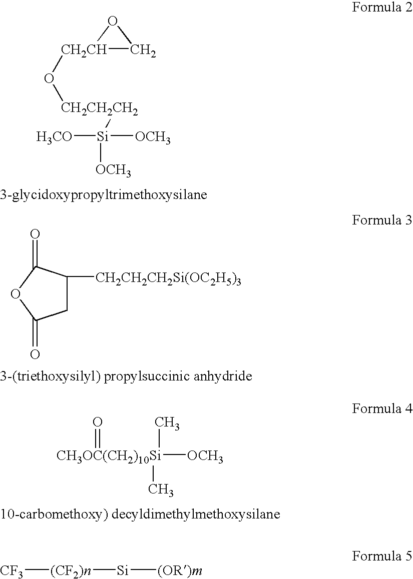

In Formula 5, —OR′ is an ethoxy group, a methoxy group, or a methoxyethoxy group, n is an integer from 0 to about 20, and m is an integer from about 1 to about 3.

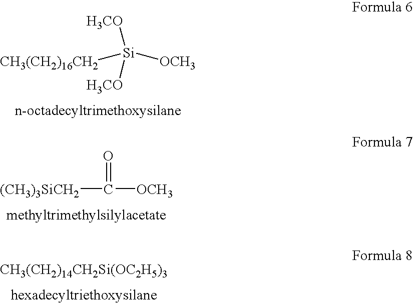

The silane coupling agent may be contained in the composite in an amount from about 0.1 weight percent (“wt %”) to about 5 wt %, and desirably from about 1 wt % to about 4 wt %, based on the weight of the electrically conducting material.

The polymer resin contained in the composite may be selected from the group consisting of epoxy resin, polyimide resin, silicon polyimide resin, silicone resin, polyurethane, and polybenzocyclobutene.

The polymer resin may be used in an amount from about 90 volume percent (“vol %”) to about 99 volT based on the total volume of the composite.

The composite may also include a binder or other organic additives.

The composite may also include a material able to increase a dielectric constant. For example, a surfactant having a head portion containing an acidic functional group may be used to form a passivation layer surrounding the electrically conducting material, thereby increasing the dielectric constant, resulting in a high-k polymer composite. The use of the surfactant in the aforementioned manner can promote and increase in the dielectric constant of the composite.

The surfactant may have a backbone and a tail portion that are connected to the head portion. As noted above, the head portion may contain an acidic functional group. The head portion of the surfactant may contain one or more acidic functional groups selected from the group consisting of —COOH, —PO₄H₂, —PO₃H, —PO₄H⁻, —SH, —SO₃H, and —SO₄H. The tail portion of the surfactant may have one or more hydrophilic or hydrophobic side chains connected to the backbone.

The head portion containing the acidic functional group may react with the oxidizable metal owing to its high affinity for the metal, thus forming a chemical bond. In contrast, the tail portion containing one or more hydrophilic or hydrophobic side chains may have a high affinity for the polymer resin. Hence, in the composite, the head portion of the surfactant may be linked to the electrically conducting material impregnated with metal oxide, while the tail portion may be oriented towards the polymer resin, thus forming a passivation layer surrounding the electrically conducting material. The use of the surfactant prevents electrical conduction or percolation between the particles of the electrically conducting, thereby ensuring a high dielectric constant for the composite.

The head portion of the surfactant may be chemically reacted with the electrically conducting material impregnated with metal oxide and thus may be bound thereto. The heat portion of the surfactant can be reacted with the electrically conducting material or with the metal oxide that is disposed upon the electrically conducting material. The head portions of the surfactants may be arranged around the electrically conducting material, and the tail portions having affinity for the polymer resin may extend radially outwards from the head portions, consequently efficiently dispersing the electrically conducting material in the polymeric resin.

Through a chemical reaction, such as, for example, the acid-base interaction between —PO₄H₂, which is the functional group on the head portion of the surfactant, and nickel oxide (NiO), which is impregnated on the surface of the electrically conducting material, a salt may be formed.

Since acidic functional groups that are used in the head portion of the surfactant may not react with another acidic surface (e.g., the acidic surface of carbon black), it may not be desirable to attempt to react the surfactant directly with the carbon black. Disposing a metal oxide layer on the electrically conductive material can overcome this problem. By introducing a ferroelectric functional group, a strong acid-base interaction between the impregnated metal oxide and the ferroelectric functional group, which can increase the dielectric constant of the composite.

The head portion of the surfactant may be selected from among compounds represented by Formulas 9 and 10 below.

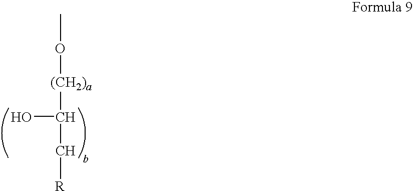

wherein R₁ is one or more selected from the group consisting of —COOH, —PO₄H₂, —PO₃H, —PO₄H⁻, —SH, —SO₃H, and —SO₄H, a is from about 0 to about 5, and b is from about 0 to about 10.

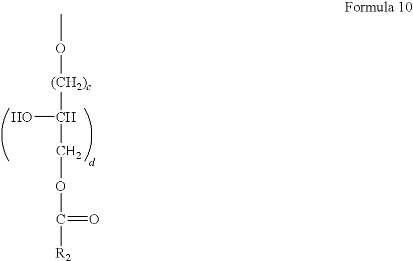

where R₂ is one or more selected from the group consisting of —COOH, —PO₄H₂, —PO₃H, —PO₄H⁻, —SH, —SO₃H, and —SO₄H, c is from about 0 to about 5, and d is from about 0 to about 10.

The backbone of the surfactant may be selected from the group consisting of polyacryl, polyurethane, polystyrene, polysiloxane, polyether, polyisobutylene, polypropylene, and polyepoxy.

The tail portion of the surfactant may include one or more selected from among compounds represented by Formulas 11 and 12 below.

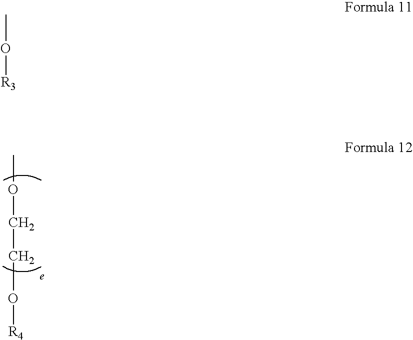

where in the Formulas 11 and 12, R₃ is a C₁₋₃₀ alkyl group, an alkene group, or an alkyne group, R₄ is a C₁₋₁₀ alkyl group, an alkene group, an alkyne group, or a C₆₋₃₀ aryl group, and e is from about 1 to about 20.

In an exemplary embodiment, the surfactant may be represented by the Formulas 13 to 17 below.

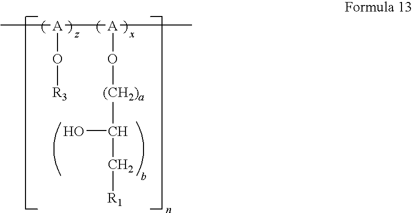

wherein A is a backbone that can include acryl, urethane, styrene, siloxane, ether, isobutylene, propylene or epoxy polymers, R₁ is selected from the group consisting of —COOH, —PO₄H₂, —PO₃H, —PO₄H⁻, —SH, —SO₃H, and —SO₄H, R₃ is a C₁₋₃₀ alkyl group, an alkene group, or an alkyne group, x and z are each from about 1 to about 50, a is from about 0 to about 5, b is from about 0 to about 10, and n is from about 1 to about 50.

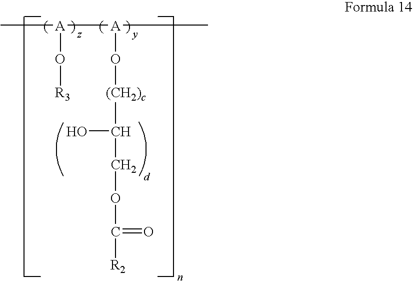

where A is a backbone that can include acryl, urethane, styrene, siloxane, ether, isobutylene, propylene or epoxy polymers, R₂ is selected from the group consisting of —COOH, —PO₄H₂, —PO₃H, —PO₄H⁻, —SH, —SO₃H, and —SO₄H, R₃ is a C₁₋₃₀ alkyl group, an alkene group, or an alkyne group, y and z are each from about 1 to about 50, c is from about 0 to about 5, d is from about 0 to about 10, and n is from about 1 to about 50.

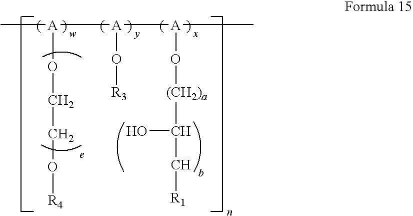

where A is a backbone that can include acryl, urethane, styrene, siloxane, ether, isobutylene, propylene or epoxy polymers, R₁ is selected from the group consisting of —COOH, —PO₄H₂, —PO₃H, —PO₄H⁻, —SH, —SO₃H, and —SO₄H, R₃ is a C₁₋₃₀ alkyl group, an alkene group, or an alkyne group, R₄ is a C₁₋₁₀ alkyl group, an alkene group, an alkyne group, or a C₆₋₃₀ aryl group, x, y and w are each from about 1 to about 50, a is from about 0 to about 5, b is from about 0 to about 10, e is from about 1 to about 20, and n is from about 1 to about 50.

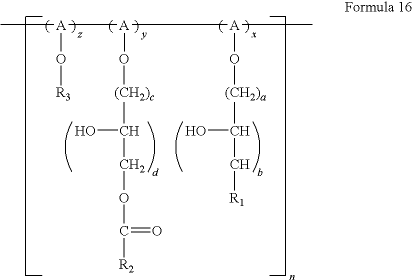

wherein A is a backbone that can include acryl, urethane, styrene, siloxane, ether, isobutylene, propylene or epoxy polymers, R₁ and R₂ are each selected from the group consisting of —COOH, —PO₄H₂, —PO₃H, —PO₄H⁻, —SH, —SO₃H, and —SO₄H, R₃ is a C₁₋₃₀ alkyl group, an alkene group, or an alkyne group, x, y and z are each from about 1 to about 50, a and c are each from about 0 to about 5, b and d are each from about 0 to about 10, and n is from about 1 to about 50.

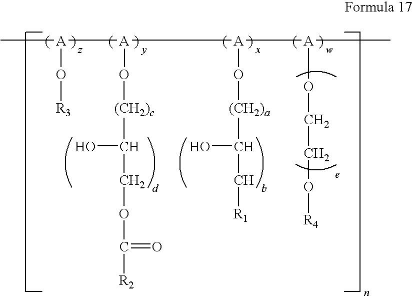

where A is a backbone that can include acryl, urethane, styrene, siloxane, ether, isobutylene, propylene or epoxy polymers, R₁ and R₂ are each selected from the group consisting of —COOH, —PO₄H₂, —PO₃H, —PO₄H⁻, —SH, —SO₃H, and —SO₄H, R₃ is a C₁₋₃₀ alkyl group, an alkene group, or an alkyne group, R₄ is a C₁₋₁₀ alkyl group, an alkene group, an alkyne group, or a C₆₋₃₀ aryl group, x, y, z and w are each from about 1 to about 50, a and c are each from about 0 to about 5, b and d are each from about 0 to about 10, e is from about 1 to about 20, and n is from about 1 to about 50.

Examples of the surfactant may include, but are not limited to, compounds represented by Formulas 18 and 19 below.

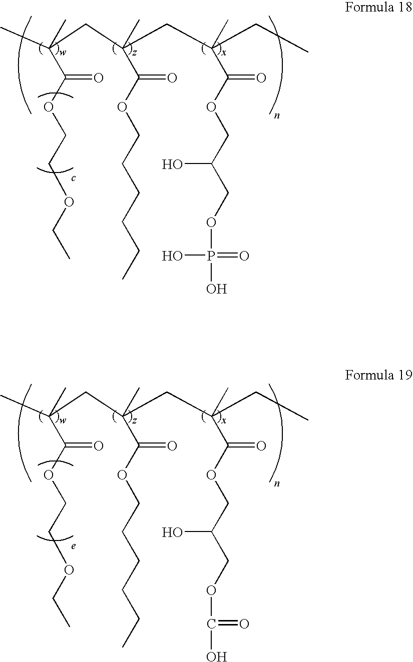

where x, y and z are each from about 1 to about 50, and n is from about 1 to about 50.

The surfactant may have a number average molecular weight from about 500 to about 10,000 grams per mole (g/mol).

The surfactant used in the exemplary embodiments may be prepared by reacting one or more compounds selected from among compounds represented by Formulas 20 and 21 below with a compound represented by Formula 22 below. A polymerization initiator may be used to facilitate the aforementioned reaction, thus obtaining a copolymer, and then reacting the copolymer thus obtained with a monomer to form one or more head portions in the presence of an acid catalyst.

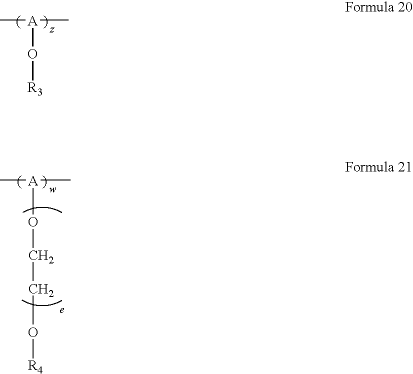

where in Formulas 20 and 21, A is a backbone, including acryl, urethane, styrene, siloxane, ether, isobutylene, propylene or epoxy polymers, R₃ is a C₁₋₃₀ alkyl group, an alkene group, or an alkyne group, R₄ is a C₁₋₁₀ alkyl group, an alkene group, an alkyne group, or a C₆₋₃₀ aryl group, z and w are each from about 1 to about 50, and e is from about 1 to about 20.

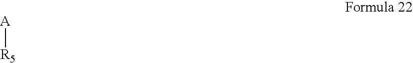

where A is a backbone that can include acryl, urethane, styrene, siloxane, ether, isobutylene, propylene or epoxy polymers, and R₅ is an epoxy group substituted with a C₁₋₁₀ alkyl group, an alkene group, an alkyne group, or a C₆₋₃₀ aryl group.

The monomer for forming one or more head portions may be selected from the group consisting of thiol compounds, phosphoric acid compounds, and sulfonic acid compounds.

Examples of the polymerization initiator may include methyl trimethylsilyl dimethylketene acetal, potassium persulfate, hydrogen peroxide, cumyl hydroperoxide, di-tert butyl peroxide, dilauryl peroxide, acetyl peroxide, benzoyl peroxide, azisobutyronitrile (AIBN) or a combination comprising at least one of the foregoing polymerization initiators.

A method for synthesizing the surfactant is described in greater detail below. For example, with reference to Reaction 1 below, polyethylene glycol methacrylate and hexyl methacrylate may be used as the tail portion, and glycidyl methacrylate may be used as the monomer for reaction with the head portion. Group Transfer Polymerization (“GTP”) may be performed, to synthesize the tail portion of the surfactant. If it is desirable to change the type of side chain, a starting material containing a different type of side chain may be used.

The tail portion thus synthesized may be reacted with the monomer for forming the head portion to obtain the surfactant in which the head portions and the tail portions are connected to the backbone. The reaction may be carried out through the additional reaction of an epoxy group and an acid in the presence of the acid or ammonium salt catalyst. In Reaction 1 below, the monomer for forming the head portion may be exemplified by phosphoric acid (H₃PO₄) or phosphorus pentoxide (P₂O₅). For the above reaction, the acid or ammonium salt catalyst may be used, and the reaction may be performed at a temperature from about room temperature (room temperature being about 23° C.) to about 130° C. for a period of time from about 30 minutes to about 15 hours under atmospheric pressure, followed by heating, refluxing and vacuum evaporation to remove the solvent, thereby obtaining a desired surfactant.

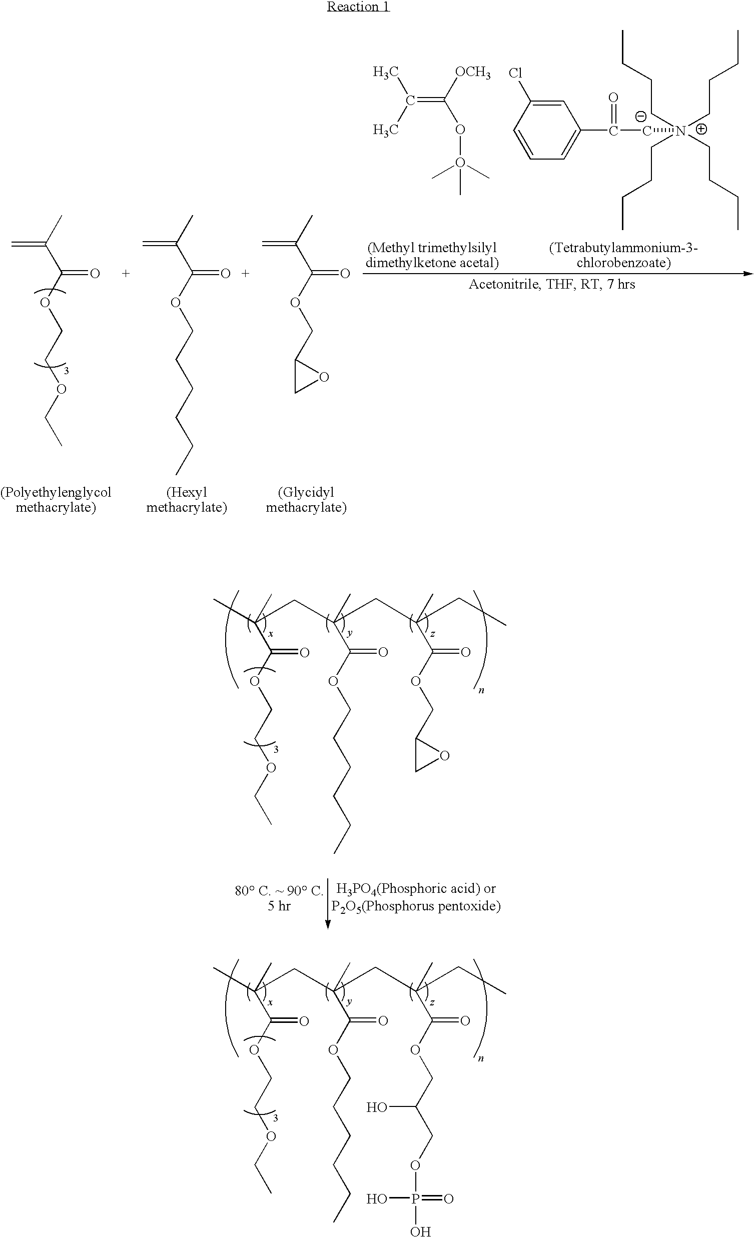

The surfactant may be used in an amount of about 10 to about 80 parts by weight based on 100 parts by weight of the electrically conducting material.

The composite s may be used in the form of a mixture with the solvent on a substrate using a simple coating process, for example, spin coating, electrophoresis deposition, casting, ink-jet printing, spraying, or offset printing.

In another embodiment, a method of manufacturing the composite may include preparing an electrically conducting material having a surface impregnated with oxidizable metal or metal oxide, mixing the electrically conducting material with a silane coupling agent and then heating the mixture at a temperature from about 100° C. to about 120° C. so that the silane coupling agent is covalently bonded to the metal oxide on the surface of the electrically conducting material, mixing the electrically conducting material covalently bonded with the silane coupling agent, a polymer resin, and a curing agent, thus forming a composition that can be used to form a composite, and curing the composition to form a composite.

The following is a brief description of the method of manufacturing the composite: the covalent bond between the electrically conducting material and the silane coupling agent may be formed, after which the electrically conducting material may be dispersed in the polymer resin along with the curing agent, thus forming the composite. The method is described in detail below.

### Preparation of Conductive Material

As noted above, the silane coupling agent may be used to form chemical bonds between the electrically conducting material and the polymer resin. In addition, the electrically conducting material having its surface impregnated with metal oxide may be used to form covalent bonds between the silane coupling agent and the electrically conducting material. In the case of the oxidizable metal, it may be oxidized even in a hydrogen atmosphere to form its oxide, allowing the electrically conducting material with a surface impregnated with the oxidizable metal or the metal oxide to be prepared. The electrically conducting material having a surface directly impregnated with metal or metal oxide may be used. Alternatively a suitable commercially available product may be used. The electrically conducting material may be selected from the group consisting of carbon black, carbon nanotubes, carbon nanowires, carbon fibers, graphite and a combination comprising at least one of the foregoing electrically conducting materials. The metal or metal oxide may be selected from the group consisting of nickel, zinc, copper, iron, mercury, silver, platinum, gold, tin, lead, aluminum, and oxides thereof. Typically, the use of a conductive material having a surface physically impregnated with metal oxide is desirable.

Covalent Bonding of the Silane Coupling Agent with the Metal Oxide on the Electrically Conductive Material

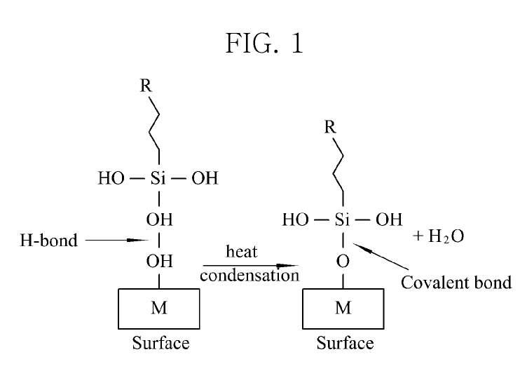

The electrically conducting material having a surface impregnated with metal or metal oxide may be mixed with the silane coupling agent, and may then be heated to about 100 to 120° C. FIG. 1 schematically shows the covalent bonding of the silane coupling agent with the metal oxide on the electrically conducting material. With reference to FIG. 1, the alkoxysilane group (Si—O—R′) of the silane coupling agent may be hydrolyzed by water, thus forming silanol, after which this silanol group may form a hydrogen bond with the surface of metal oxide on the surface of the conductive material, followed by performing heat condensation, thereby forming a Si—O-M covalent bond, where M represents the metal. The other functional group R may be bound to the polymer resin. Consequently, the inorganic material may be chemically bonded with the organic material, thus reducing the dielectric loss.

The silane coupling agent may contain one or more functional groups selected from amongst an alkyl group, a vinyl group, a phenyl group, an epoxy group, a carbonyl group, a fluorocarbon group, an ether group, a succinic group, a carboxyl group, an ester group, a mercapto group, an amide group, an amino group, a cyano group, and a nitro group.

The silane coupling agent may be selected from the group consisting of an epoxy group-containing silane coupling agent, for example, 2-(3,4-epoxycyclohexyl)-ethyl trimethoxysilane, 3-glycidoxytrimethoxysilane, 3-glycidoxypropyltriethoxysilane, and 3-glycidoxypropyltrimethoxysilane of Formula 2 below; an amine group-containing silane coupling agent, for example, N-(2-aminoethyl)-3-aminopropylmethyldimethoxysilane, N-(2-aminoethyl)-3-aminopropyltrimethoxysilane (H₂N (CH₂)₂NH(CH₂)₃Si(OCH₃)₃), N-(2-aminoethyl)-3-aminopropyltriethoxysilane, 3-aminopropyltrimethoxysilane, 3-aminopropyltriethoxysilane, 3-triethoxysilyl-N-(1,3-dimethylbutylidene)propylamine, and N-phenyl-3-aminopropyltrimethoxysilane; a mercapto group-containing silane coupling agent, for example, 3-mercaptopropylmethyldimethoxysilane and 3-mercaptopropyltriethoxysilane; an isocyanate group-containing silane coupling agent, for example, 3-isocyanatepropyltriethoxysilane, and compounds of Formulas 3 to 8 below. The aforementioned silane coupling agents may have functional groups curable along with the polymer resin thereby producing a chemical bond between the electrically conducting material and the polymer resin in the composite.

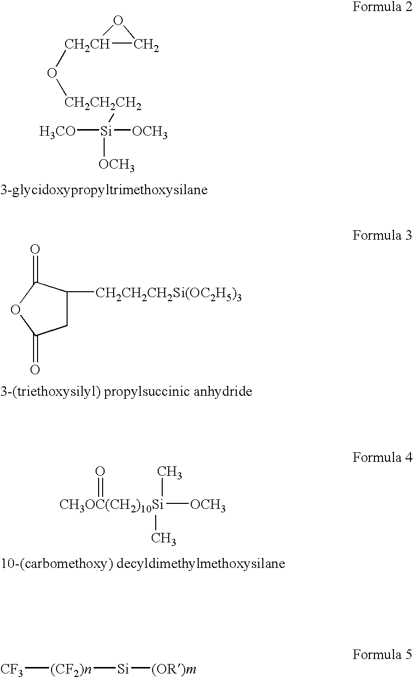

In Formula 5, —OR′ is an ethoxy group, a methoxy group, or a methoxyethoxy group, n is an integer from 0 to about 20, and m is an integer from about 1 to about 3.

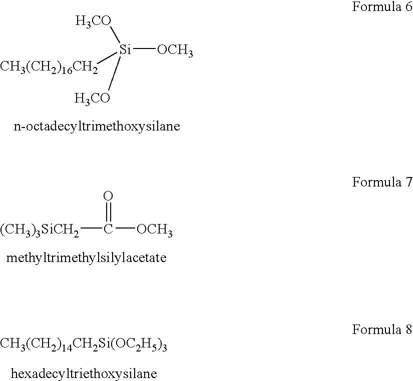

In the method according to the exemplary embodiments, the silane coupling agent may be used in an amount of about 0.1 wt % to about 5 wt %, and desirably about 1 wt % to about 4 wt %, based on the weight of the electrically conducting material.

### Formation of Composition for Forming the Composite

In order to form the composite, the electrically conducting material is covalently bonded with the silane coupling agent. The electrically conducting material with the silane coupling agent bonded thereto, the polymer resin, and the curing agent are mixed together to produce the composition for forming the composite. The polymer resin may be selected from the group consisting of epoxy resins, polyimide resins, silicon polyimide resins, silicone resins, polyurethane resins, polybenzocyclobutene resins, and a combination comprising at least one of the foregoing resins.

Examples of the curing agent are hexahydrophthalic anhydride (HHPA), nadic methyl anhydride (NMA), 4-methyl-4-cyclohexene-1,2-dicarboxyl anhydride, or a combination comprising at least one of the foregoing curing agents.

The composition for forming the composite includes a catalyst, and examples of the catalyst include a phosphine- or boron-based curing accelerator, an imidazole-based curing accelerator, or a combination comprising at least one of the foregoing catalyst.

Examples of the phosphine-based curing accelerator may include triphenylphosphine, tri-o-tolylphosphine, tri-m-tolylphosphine, tri-p-tolylphosphine, tri-2,4-xylylphosphine, tri-2,5-xylylphosphine, tri-3,5-xylylphosphine, tribenzylphosphine, tris(p-methoxyphenyl)phosphine, tris(p-tert-butoxyphenyl)phosphine, diphenylcyclohexylphosphine, tricyclohexylphosphine, tributylphosphine, tri-tert-butylphosphine, tri-n-octylphosphine, diphenylphosphinostyrene, diphenylphosphinouschloride, tri-n-octylphosphine oxide, diphenylphosphinyl hydroquinone, tetrabutylphosphonium hydroxide, tetrabutylphosphonium acetate, benzyltriphenylphosphonium hexafluoroantimonate, tetraphenylphosphonium tetraphenylborate, tetraphenylphosphonium tetra-p-tolylborate, benzyltriphenylphosphonium tetraphenylborate, tetraphenylphosphonium tetrafluoroborate, p-tolyltriphenylphosphonium tetra-p-tolylborate, triphenylphosphine triphenylborane, 1,2-bis(diphenylphosphino)ethane, 1,3-bis(diphenylphosphino)propane, 1,4-bis(diphenylphosphino)butane, 1,5-bis(diphenylphosphino)pentane, and a combination comprising at least one of the foregoing phosphine-based curing accelerators. Examples of the boron-based curing accelerator may include phenyl boronic acid, 4-methylphenyl boronic acid, 4-methoxyphenyl boronic acid, 4-trifluoromethoxyphenyl boronic acid, 4-tert-butoxyphenyl boronic acid, 3-fluoro-4-methoxyphenyl boronic acid, pyridine-triphenylborane, 2-ethyl-4-methyl imidazolium tetraphenylborate, 1,8-diazabicyclo[5.4.0]undecene-7-tetraphenylborate, 1,5-diazabicyclo[4.3.0]nonene-5-tetraphenylborate, lithium triphenyl(n-butyl)borate, and a combination comprising at least one of the foregoing boron-based curing accelerators. Examples of the imidazole-based curing accelerator may include 2-methylimidazole, 2-undecylimidazole, 2-heptadecylimidazole, 2-ethyl-4-methylimidazole, 2-phenylimidazole, 2-phenyl-4-methylimidazole, 1-benzyl-2-phenylimidazole, 1,2-dimethylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 1-cyanoethyl-2-undecylimidazolium-trimellitate, 1-cyanoethyl-2-phenylimidazolium-trimellitate, 2,4-diamino-6-[2′-methylimidazoly-(1′)]-ethyl-s-triazine, 2,4-diamino-6-[2′-undecylimidazoly-(1′)]-ethyl-s-triazine, 2,4-diamino-6-[2′-ethyl-4′-methylimidazoly-(1′)]-ethyl-s-triazine, 2,4-diamino-6-[2′-methylimidazoly-(1′)]-ethyl-s-triazine isocyanuric acid adduct dihydrate, 2-phenylimidazole isocyanuric acid adduct, 2-methylimidazole isocyanuric acid adduct dihydrate, 2-phenyl-4,5-dihydroxymethylimidazole, 2-phenyl-4-methyl-5-hydroxymethylimidazole, 2,3-dihyro-1H-pyrrolo[1,2-a]benzimidazole, 4,4′-methylene bis(2-ethyl-5-methylimidazole, 2-methylimidazoline, 2-phenylimidazoline, 2,4-diamino-6-vinyl-1,3,5-triazine, 2,4-diamino-6-vinyl-1,3,5-triazine isocyanuric acid adduct, 2,4-diamino-6-methacryloyloxylethyl-1,3,5-triazine isocyanuric acid adduct, 1-(2-cyanoethyl)-2-ethyl-4-methylimidazole, 1-cyanoethyl-2-methylimidazole, 1-(2-cyanoethyl)2-phenyl-4,5-di-(cyanoethoxymethyl)imidazole, 1-acetyl-2-phenylhydrazine, 2-ethyl-4-methyl imidazoline, 2-benzyl-4-methyl dimidazoline, 2-ethyl imidazoline, 2-pheny imidazole, 2-phenyl-4,5-dihydroxymethylimidazole, melamine, dicyandiamide, and a combination comprising at least one of the foregoing imidazole-based curing accelerators.

### Curing of the Composition for Forming the Composite

The composition for forming the composite is cured thereby obtaining a polymer composite having the electrically conducting material dispersed therein. The curing process may be performed in such a manner that the composition is heated to a temperature of about 150 to about 200° C. from room temperature at a heating rate of about 10° C./minute and is then allowed to remain at the temperature for about 1.5 to about 2 hours. When the polymer resins are cured in the curing process, the functional groups of the silane coupling agent may be cured together, thus forming a chemical bond. This curing reduces the number of free dangling bonds, which consequently reduces the dielectric loss in the composite.

In another exemplary embodiment, a capacitor may include the aforementioned composite. In the capacitor, the composite may be used as a dielectric between electrodes facing each other. A capacitor having a layered structure or a non-layered structure may be used between the electrodes if desired.

The capacitor including the composite may be simply and inexpensively manufactured using a PTF process, and also may ensure reliability when embedded within the organic substrate while displaying the desired dielectric capacitance.

The composite according to the exemplary embodiments may be applied not only to the capacitor but also to electron guns or electrodes of field emission displays (“FEDs”), FEDs, transparent electrodes of liquid crystal displays, light-emitting materials for organic electroluminescent devices, buffer materials, electron transport materials, and hole transport materials.

A better understanding of the exemplary embodiments will be described in more detail with reference to the following examples. However, these examples are given merely for the purpose of illustration and are not to be construed to limit the scope of the embodiments.

### EXAMPLE 1

About 2 grams (“g”) of carbon black M2300 (Mitsubishi Chemical) having a surface impregnated with nickel oxide (NiO) and about 0.08 g of 2 wt % 3-glycidoxypropylmethyldiethoxysilane are mixed and then heated to about 100° C.

Next, the heated mixture is mixed with about 2.127 g of diglycidyl ether of bisphenol A (DGEBA), about 0.964 g of hexahydrophthalic anhydride (HHPA, Aldrich) and about 0.015 g of imidazole (I) (Aldrich), thus preparing a paste. Subsequently, the paste is heated at about 160° C. for about 1.5 hours, thus obtaining the composite.

### EXAMPLE 2

A composite is manufactured in the same manner as in Example 1, with the exception that about 0.06 g of 3 wt % 3-glycidoxypropylmethyldiethoxysilane is used instead of the 0.08 g of 2 wt % 3-glycidoxypropylmethyldiethoxysilane.

### EXAMPLE 3

Instead of 3-glycidoxypropylmethyldiethoxysilane in Example 1, 0.02 g of 1 wt % 3-(triethoxysilyl)propyl succinic anhydride is used, and then the heating to 100° C. is performed.

Thereafter, about 0.561 g of the heated mixture is mixed with about 0.0056 g of n-tetradecyl phosphoric acid (TDPA) dissolved in ethyl acetate. The solution thus obtained is mixed with about 2.127 g of diglycidyl ether of bisphenol A (DGEBA), about 0.964 g of hexahydrophthalic anhydride (HHPA, Aldrich) and about 0.015 g of imidazole (I) (Aldrich), thus preparing a paste. Subsequently, the paste is heated at about 190° C. for about 2 hours, thus obtaining the composite.

### COMPARATIVE EXAMPLE 1

A composite is manufactured in the same manner as in Example 1, with the exception that the silane coupling agent is not added.

### COMPARATIVE EXAMPLE 2

The carbon black M2300 (not impregnated with the NiO), of Example 1 is used alone without the addition of the silane coupling agent, and manufacturing the composite. As such, the amount of M2300 is about 0.308 g. About 1.577 g of 3,4-epoxycyclohexylmethyl-3,4-epoxycyclohexane-carboxylate as the epoxy resin, about 1.051 g of hexahydro-4-methylphthalic anhydride as the curing agent, about 0.015 g of 1-methyl imidazole as the catalyst are used to prepare a paste, which is then cured under the same conditions as in Example 1.

### EXPERIMENTAL EXAMPLE

The dielectric constant and dielectric loss of the composite of each of Examples 1 to 3 and Comparative Examples 1 and 2 are measured for an average measurement time of about 4 sec/point at a frequency from about 10 kHz to about 10 MHz using an impedance analyzer. The impedance analyzer was a HP 4194A. Under conditions in which the voltage that is applied is varied from about −3.0 to about 3.0 volts and the applied voltage interval is set to about 0.10 seconds, capacitance is measured at a frequency of 1 MHz and then substituted into the following equations, and thus the dielectric constant is calculated. The results are shown in Table 1 below.

$$\begin{matrix}{ɛ}_{0} = 8.854 \times {10}^{- 12} [ F / m ] \\ r = 150 \times {10}^{- 6} [ m ] \\ {ɛ}_{r} = \frac{Cd}{{ɛ}_{0} A} = \frac{Cd}{{ɛ}_{0} π {r}^{2}}\end{matrix}$$

where C is the capacitance having units of Farads, d is electrode to electrode distance measured in micrometers (“μm”), r is a radius of electrode having units in μm, A is electrode surface measured in square micrometers (μm²), εₒ is dielectric constant in a vacuum=8.854×10⁻¹² Farads per meter [F/m], and εᵣ is dielectric constant of sample (composite).

For these tests, d is 30 micrometers (“μm”), and r is 175 μm.

Table 1 below shows the dielectric constant, the dielectric loss, and the thickness in Examples 1 to 3 and Comparative Examples 1 and 2.

TABLE 1

| | | Amount of Silane | | |
|---|---|---|---|---|
| | | Coupling Agent | Dielectric | Dielectric |
| | NiO | (based on Carbon Black) | Constant | Loss (%) |
| Ex. 1 | ∘ | 2 wt % | 16.6 | 2.90 |
| Ex. 2 | ∘ | 3 wt % | 24.6 | 9.25 |
| Ex. 3 | ∘ | 1 wt % | 600 | 6 |
| C. Ex. 1 | ∘ | 0 wt % | 22.3 | 12.2 |
| C. Ex. 2 | x | 0 wt % | 242.7 | 75.1 |

It is to be noted that the dielectric loss can be expressed as a percentage or as a number. For example, a dielectric loss of 0.2 can also be expressed as 20%. The dielectric loss is the loss of energy that manifests itself as a rise in temperature of the dielectric material, when it is placed in an alternating electric field.

The effect of impregnating metal oxide on the surface of the conductive material and the effect resulting from the silane coupling agent are apparent in Table 1. In Comparative Example 1 without the use of the silane coupling agent, the dielectric loss is seen to be greater than 10%. In Comparative Example 2 using carbon black not impregnated with metal oxide, the dielectric loss is determined to be 75.1%. In Examples 1 and 2 containing both carbon black impregnated with the metal oxide and the silane coupling agent, the dielectric loss is seen to be lower than 10%.

Also, referring to Table 1, when the dielectric loss is lower than 10%, the dielectric constant is determined to be about 10˜20. However, in Example 3 using the phosphate-based surfactant, the dielectric loss is determined to be 6% and the dielectric constant is determined to be 600, which is the greatest in the experimental examples of M2300. Without being limited to theory, this result occurs because the inside of the matrix is highly cured, thus obtaining a low dielectric loss, and also because the effective charge in the matrix is increased due to the presence of the phosphate, thereby leading to an increased dielectric constant.

From the experimental results shown above, it can be seen that the presence of the metal oxide on the electrically conducting particles, and the presence of the silane coupling agent which bonds the metal oxide to the polymer resin reduces the percolation of electrical conductivity through the electrically conducting particles. Thus the transfer of electrical conductivity is reduced, while at the same time, the dielectric constant is increased and the dielectric loss in minimized.

Thus the flow of electrical conductivity along the surface of the electrically conducting material in a composite may be prevented, thus reducing the dielectric loss.

Although exemplary embodiments have been disclosed for illustrative purposes, those skilled in the art will appreciate that various modifications, additions and substitutions are possible, without departing from the scope and spirit of the invention as disclosed in the accompanying claims.

What is claimed is:

1. A composite, comprising:
a polymer resin;
an electrically conducting material dispersed in the polymer resin; the electrically conducting material having a surface impregnated with a metal oxide; the metal oxide being covalently bonded with a silane coupling agent.

2. The composite of claim 1, wherein the metal oxide is selected from the group consisting of oxides of nickel, zinc, copper, iron, mercury, silver, platinum, gold, tin, lead, aluminum, and a combination comprising at least one of the foregoing metal oxides.

3. The composite of claim 1, wherein the electrically conducting material is selected from the group consisting of carbon black, carbon nanotubes, carbon nanowires, carbon fibers, graphite, and a combination comprising at least one of the foregoing electrically conducting materials.

4. The composite of claim 1, wherein the metal oxide is physically impregnated on a surface of the electrically conducting material.

5. The composite of claim 1, where the silane coupling agent contains one or more functional groups selected from the group consisting of an alkyl group, a vinyl group, a phenyl group, an epoxy group, a carbonyl group, a fluorocarbon group, an ether group, a succinic group, a carboxyl group, an ester group, a mercapto group, an amide group, an amino group, a cyano group, and a nitro group.

6. The composite of claim 5, wherein the silane coupling agent is selected from the group consisting of 2-(3,4-epoxycyclohexyl)-ethyltrimethoxysilane, 3-glycidoxytrimethoxysilane, 3-glycidoxypropyltriethoxysilane, and 3-glycidoxypropyltrimethoxysilane of Formula 1 below, N-(2-aminoethyl)-3-aminopropylmethyldimethoxysilane, N-(2-aminoethyl)-3-aminopropyltrimethoxysilane (H₂N (CH₂)₂NH(CH₂)₃Si(OCH₃)₃), N-(2-aminoethyl)-3-aminopropyltriethoxysilane, 3-aminopropyltrimethoxysilane, 3-aminopropyltriethoxysilane, 3-triethoxysilyl-N-(1,3-dimethylbutylidene)propylamine, N-phenyl-3-aminopropyltrimethoxysilane, 3-mercaptopropyl methyldimethoxysilane, 3-mercaptopropyltriethoxysilane, 3-isocyanatepropyltriethoxysilane, and compounds represented by Formulas 2 to 8 below: 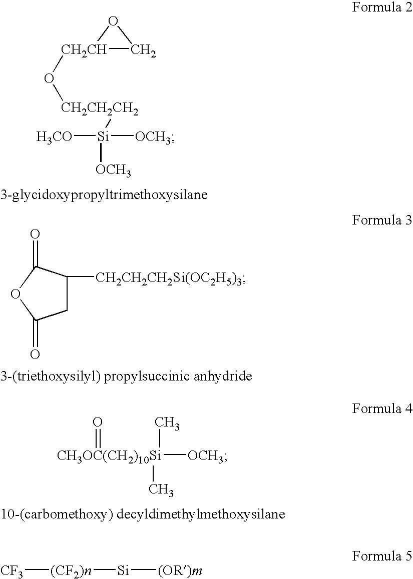
where in Formula 5, —OR′ is an ethoxy group, a methoxy group, or a methoxyethoxy group, n is an integer from 0 to about 20, and m is an integer from about 1 to about 3;

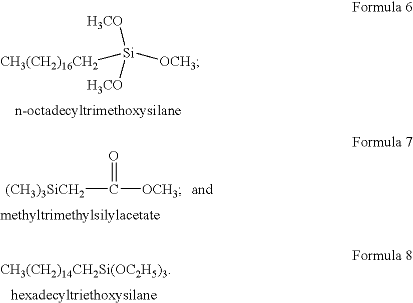

7. The composite of claim 1, wherein the silane coupling agent is used in an amount from about 0.1 weight percent to about 5 weight percent, based on the total weight of the electrically conducting material.

8. The composite of claim 1, wherein the polymer resin is selected from the group consisting of an epoxy resin, a polyimide resin, a silicon polyimide resin, a silicone resin, a polyurethane, a polybenzocyclobutene, and a combination comprising at least one of the foregoing polymer resins.

9. The composite of claim 1, wherein the polymer resin and functional groups of the silane coupling agent are chemically bonded with each other in the composite.

10. The composite of claim 1, further comprising a surfactant composed of a backbone and a tail portion and a head portion; the tail portion and the head portion being bonded to the backbone, the head portion containing acidic functional groups selected from the group consisting of COOH, —PO₄H₂, —PO₃H, —PO₄H⁻, —SH, —SO₃H, and —SO₄H.

11. The composite of claim 10, wherein the head portion of the surfactant is selected from the group consisting of compounds represented by Formulas 9 and 10 below: 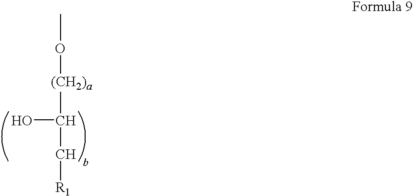
where R₁ is selected from the group consisting of —COOH, —PO₄H₂, —PO₃H, —PO₄H⁻, —SH, —SO₃H, and —SO₄H, a is from about 0 to about 5, and b is from about 0 to about 10; and 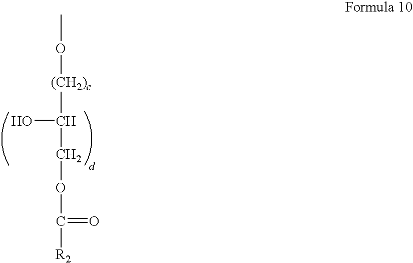
where R₂ is selected from the group consisting of —COOH, —PO₄H₂, —PO₃H, —PO₄H⁻, —SH, —SO₃H, and —SO₄H, c is from about 0 to about 5, and d is from about 0 to about 10.

12. The composite of claim 10, wherein the surfactant is represented by Formulas 13 to 17 below: 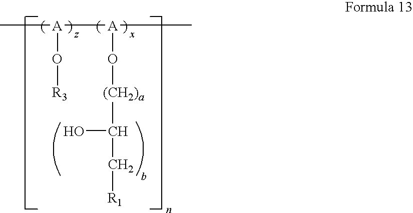
wherein A is a backbone including acryl, urethane, styrene, siloxane, ether, isobutylene, propylene or epoxy polymers, R₁ is selected from the group consisting of —COOH, —PO₄H₂, —PO₃H, —PO₄H⁻, —SH, —SO₃H, and —SO₄H, R₃ is a C₁₋₃₀ alkyl group, an alkene group, or an alkyne group, x and z are each from about 1 to about 50, a is from about 0 to about 5, b is from about 0 to about 10, and n is from about 1 to about 50; 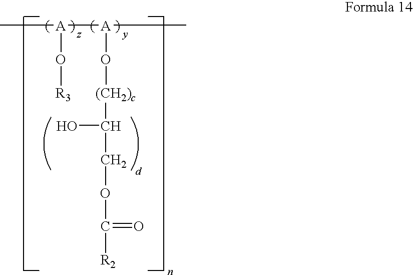
wherein A is a backbone including acryl, urethane, styrene, siloxane, ether, isobutylene, propylene or epoxy polymers, R₂ is selected from the group consisting of —COOH, —PO₄H₂, —PO₃H, —PO₄H⁻, —SH, —SO₃H, and —SO₄H, R₃ is a C₁₋₃₀ alkyl group, an alkene group, or an alkyne group, y and z are each from about 1 to about 50, c is from about 0 to about 5, d is from about 0 to about 10, and
n is from about 1 to about 50; 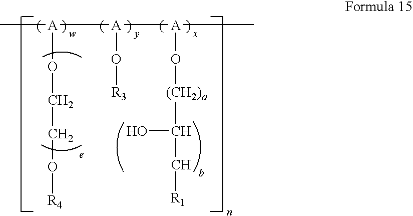
wherein A is a backbone including acryl, urethane, styrene, siloxane, ether, isobutylene, propylene or epoxy polymers, R₁ is selected from the group consisting of —COOH, —PO₄H₂, —PO₃H, —PO₄H⁻, —SH, —SO₃H, and —SO₄H, R₃ is a C₁₋₃₀ alkyl group, an alkene group, or an alkyne group, R₄ is a C₁₋₁₀ alkyl group, an alkene group, an alkyne group, or a C₆₋₃₀ aryl group, x, y and w are each from about 1 to about 50, a is from about 0 to about 5, b is from about 0 to about 10, e is from about 1 to about 20, and n is from about 1 to about 50; 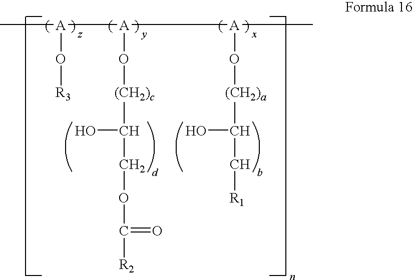
wherein A is a backbone including acryl, urethane, styrene, siloxane, ether, isobutylene, propylene or epoxy polymers, R₁ and R₂ are each selected from the group consisting of —COOH, —PO₄H₂, —PO₃H, —PO₄H⁻, —SH, —SO₃H, and —SO₄H, R₃ is a C₁₋₃₀ alkyl group, an alkene group, or an alkyne group, x, y and z are each from about 1 to about 50, a and c are each from about 0 to about 5, b and d are each from about 0 to about 10, and n is from about 1 to about 50; and 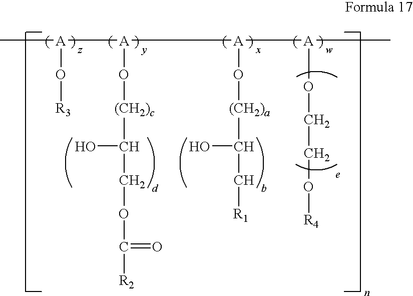
wherein A is a backbone including acryl, urethane, styrene, siloxane, ether, isobutylene, propylene or epoxy polymers, R₁ and R₂ are each selected from the group consisting of —COOH, —PO₄H₂, —PO₃H, —PO₄H⁻, —SH, —SO₃H, and —SO₄H, R₃ is a C₁₋₃₀ alkyl group, an alkene group, or an alkyne group, R₄ is a C₁₋₁₀ alkyl group, an alkene group, an alkyne group, or a C₆₋₃₀ aryl group, x, y, z and w are each from about 1 to about 50, a and c are each from about 0 to about 5, b and d are each from about 0 to about 10, e is from about 1 to about 20, and n is from about 1 to about 50.

13. A method of manufacturing a composite, comprising:
disposing an oxidizable metal or a metal oxide on a surface of an electrically conducting material;
mixing the electrically conducting material with a silane coupling agent to form a mixture;
heating the mixture to a temperature of about 100° C. to about 120° C. so that the silane coupling agent is covalently bonded with the metal oxide on the surface of the electrically conducting material;
mixing the electrically conducting material covalently bonded with the silane coupling agent with a polymer resin, and a curing agent to form a composition for forming a composite; and
curing the composition for forming a composite.

14. The method of claim 13, wherein the metal or metal oxide is selected from the group consisting of nickel, zinc, copper, iron, mercury, silver, platinum, gold, tin, lead, aluminum, and oxides thereof.

15. The method of claim 13, wherein the electrically conducting material is selected from the group consisting of carbon black, carbon nanotubes, carbon nanowires, carbon fibers, graphite, and a combination comprising at least one of the foregoing electrically conducting materials.

16. The method of claim 13, wherein the metal oxide is physically impregnated on the surface of the electrically conducting material.

17. The method of claim 13, wherein the silane coupling agent contains one or more functional groups selected from the group consisting of an alkyl group, a vinyl group, a phenyl group, an epoxy group, a carbonyl group, a fluorocarbon group, an ether group, a succinic group, a carboxyl group, an ester group, a mercapto group, an amide group, an amino group, a cyano group, and a nitro group.

18. The method of claim 13, wherein the silane coupling agent is used in an amount of about 0.1 weight percent to about 5 weight percent based on the weight of the electrically conducting material.

19. The method of claim 13, wherein the curing is conducted in a manner such that the composition is heated from room temperature to a temperature of about 200° C. at a heating rate of up to about 10° C./minute and is then maintained at the temperature for about 1.5 to about 2 hours.

20. A capacitor, comprising the composite of claim 1.
